(19) United States
(12) Patent Application Publication
(10) Pub. No.: US 2018/0229669 A1
(43) Pub. Date: Aug. 16, 2018

(54) VEHICLE-MOUNTED 360 DEGREE FIELD OF VIEW SURVEILLANCE SYSTEMS

(71) Applicants: Timothy Don McKibben, Colorado Springs, CO (US); Thomas John Mckibben, Colorado Springs, CO (US)

(72) Inventors: Timothy Don McKibben, Colorado Springs, CO (US); Thomas John Mckibben, Colorado Springs, CO (US)

(21) Appl. No.: 15/431,498

(22) Filed: Feb. 13, 2017

(51) Int. Cl. B60R 11/04; G01C 11/02

(52) U.S. Cl. CPC B60R 11/04; H04N 5/23238; B60R 2300/303; G01C 11/02

(57) ABSTRACT

A method of collecting information via a vehicle, the method including arming a panoramic surveillance system, triggering the surveillance system, obtaining a series of instantaneous 360 degree panoramic images and storing the series of panoramic images. The panoramic surveillance system may include a panoramic camera system mounted to the roof of a vehicle, a control system in electronic communication with the camera system, a processor unit configured to process electronic instructions, data storage configured to store image data, and a short-range receiver configured to receive instructions and pass them to the processor unit.

### BACKGROUND

The present disclosure relates generally to visual surveillance systems. In particular, vehicle-mounted 360 degree field of view surveillance systems are described.

Known vehicle-mounted visual surveillance systems are not entirely satisfactory for the range of applications in which they are employed. For example, existing vehicle-mounted surveillance systems are generally not capable of capturing 360 degree panoramic images (still images and/or video) of the surroundings of the vehicle. Furthermore, existing vehicle surveillance systems do not capture panoramic images of the surroundings of the vehicle while simultaneously capturing images (still images and/or video) of the interior of the vehicle. In addition, conventional vehicle surveillance systems are not capable of recording the images and/or wirelessly transmitting the images for remote viewing and/or storage.

Thus, there exists a need for vehicle surveillance systems that improve upon and advance the design of known such systems. Examples of new and useful vehicle surveillance systems relevant to the needs existing in the field are discussed below.

### SUMMARY

A method of collecting information via a vehicle, the method including arming a panoramic surveillance system, triggering the surveillance system, obtaining a series of instantaneous 360 degree panoramic images and storing the series of panoramic images. The panoramic surveillance system may include a panoramic camera system mounted to the roof of a vehicle, a control system in electronic communication with the camera system, a processor unit configured to process electronic instructions, data storage configured to store image data, and a short-range receiver configured to receive instructions and pass them to the processor unit.

In some embodiments, the panoramic surveillance system may comprise a wireless remote unit to trigger the system a short distance from the vehicle. In some embodiments, the panoramic surveillance system may include a long-range transmitting system to transmit image data and audio data to remote server. In some embodiments, the panoramic surveillance system may be triggered from a long distance via the long range transmitting system.

In some embodiments, the panoramic surveillance system may include an auxiliary camera system mounted inside the vehicle to capture image and audio data from the interior of the vehicle.

### BRIEF DESCRIPTION OF THE DRAWINGS

FIG. 1 is a perspective view of a 360 degree panoramic vehicle mounted surveillance system, including a panoramic camera system mounted to the lightbar of a police vehicle.

FIG. 2 is a cross-sectional view of a panoramic camera system of FIG. 1.

FIG. 3 is a perspective view of a wireless remote unit of the system of FIG. 1.

FIG. 4 is a perspective view the interior of a vehicle equipped with 360 degree panoramic vehicle mounted surveillance system, including an auxiliary camera system to monitor the interior of the vehicle.

FIG. 5 is a perspective view of an exterior housing for a microphone of the 360 degree panoramic vehicle mounted surveillance system.

FIG. 6 is a plan view of activities being captured via a plurality of 360 degree panoramic vehicle mounted surveillance systems mounted on police vehicles.

### DETAILED DESCRIPTION

The disclosed panoramic surveillance systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various vehicle surveillance systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

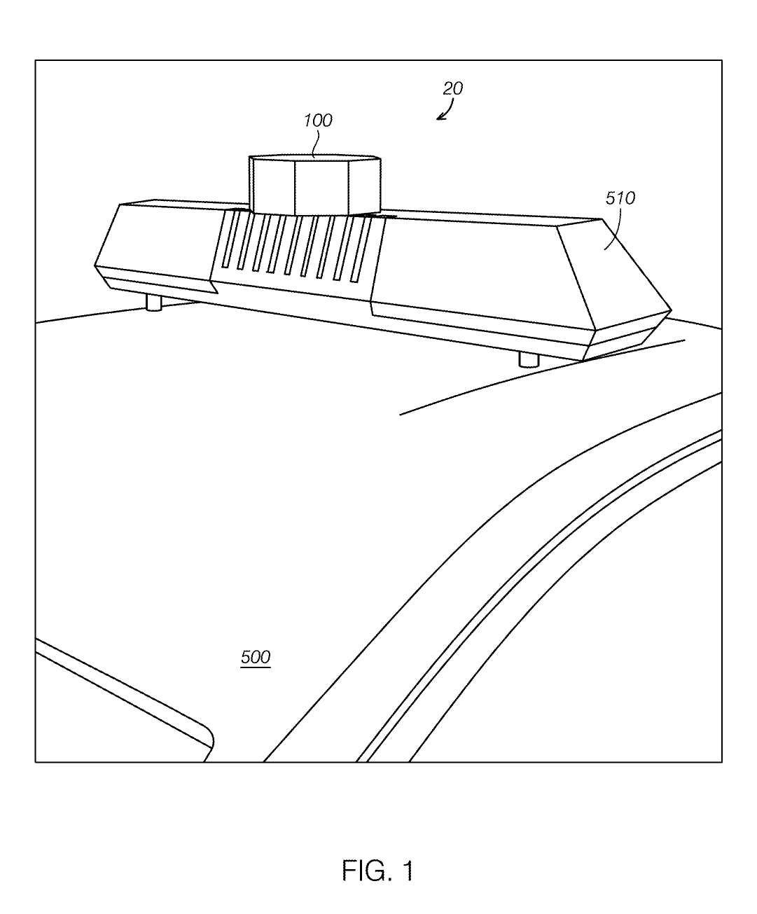

With reference to FIGS. 1-6, a first example of a 360 degree panoramic vehicle mounted surveillance system, panoramic surveillance system 20, will now be described. The reader will appreciate from the figures and description below that panoramic surveillance system 20 addresses shortcomings of conventional vehicle surveillance systems.

For example, panoramic surveillance system 20 may capture images and sound from in and around a vehicle, for example, a police or military vehicle. 360 degree panoramic images (still images and/or video) of the surroundings of the vehicle as well as sense and record sounds from environment around the vehicle. Furthermore, panoramic surveillance system 20 may capture images (still images and/or video) of the interior of the vehicle as well as sense and record sounds from the interior of the vehicle. The captured images and sounds may then be wireless transmitted to a remote server for viewing and/or storage.

Panoramic surveillance system 20 includes a panoramic camera system 100 mounted on a vehicle 500, and a control system (not pictured). In some embodiments, the panoramic surveillance system 20 may include one or more microphones housed in an exterior housing 110. In some embodiments, the panoramic surveillance system 20 may include an auxiliary camera system comprising one or more interior cameras 410, 412, 420. In some embodiments, the auxiliary camera system may include one or more interior microphones.

In some embodiments, the panoramic surveillance system 20 may include a short-range wireless transmitter to allow a user to give instructions to the vehicle surveillance system. In some embodiments, the panoramic surveillance system 20 may include a long-range wireless transmitting system to transmit image data to a remote server

As can be seen in FIG. 1, panoramic camera system 100 may be mounted atop lightbar 510 of patrol car 500. By positioning panoramic camera system 100 on top of lightbar 510, the panoramic camera system 100 can capture unobstructed images from a 360 degree field of view around patrol car 510. In other embodiments, panoramic camera system 100 may be mounted on another vehicle, such as a military vehicle or a civilian vehicle.

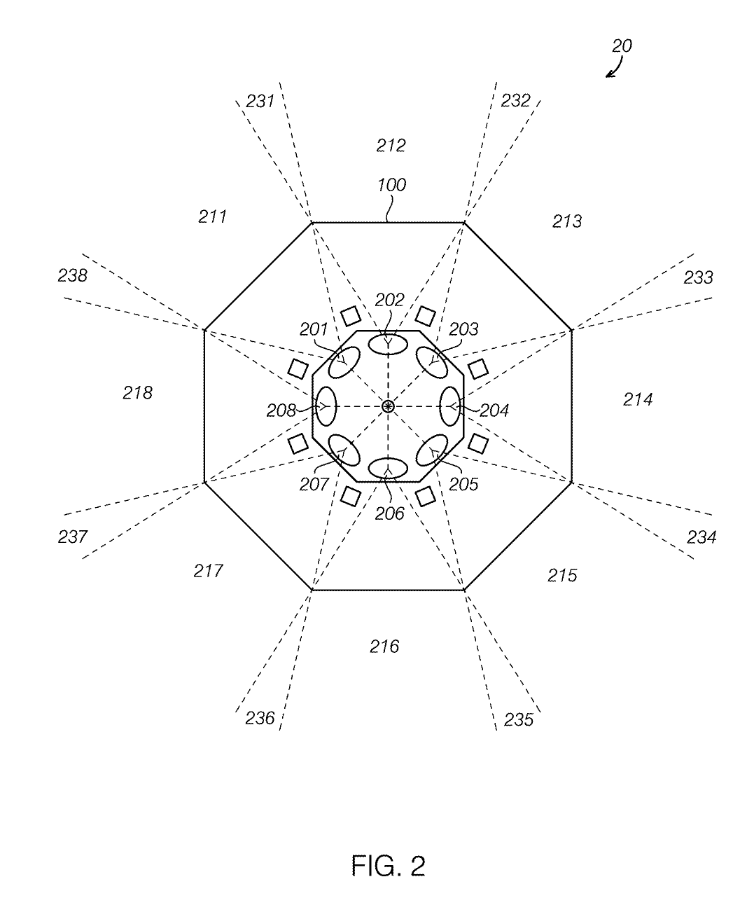

As can be seen in FIG. 2, panoramic camera system 100 may comprise a plurality of digital camera lenses 201-208. Each of the plurality of camera lenses 201-208 may have a respective field of view 211-218. The plurality of camera lenses 201-208 may be arraigned around a common center point, facing outward.

The field of view of each camera lens may overlap with the field of view of its neighboring lenses, thus forming overlap sections 231-238. For example, field of view 215 of camera lens 205 may overlap with both field of view 214 (of camera lens 204) and field of view 216 (of camera lens 206). In this manner, panoramic camera system 100 may monitor and capture images from every possible angle around the police cruiser 500.

In some embodiments, each of the cameras of the panoramic camera system may capture an image simultaneously. The simultaneous images may then be stitched together via the control system to produce an instantaneous 360 degree panoramic image. A series of such instantaneous 360 degree panoramic images may be produced in rapid succession in order to create panoramic video.

As used herein, “instantaneous 360 degree panoramic image” means a panoramic image that depicts a single instant in time. In this regard, an instantaneous 360 degree panoramic image cannot be produced via rotation of a single lens.

In the illustrated embodiment, panoramic camera system 100 includes eight camera lenses arranged as described above. In other embodiments, the panoramic camera system may include fewer or additional camera lenses, so long as they are arranged such that the field of view of each lens overlaps with those of its neighbors such that the lenses are configured to receive electromagnetic radiation (e.g., visible light) from a 360 degree field of view.

In some embodiments, the panoramic camera system 100 may include a plurality of infrared light sources. The infrared light sources may be arranged in similar manner to the camera lenses 201-208 such that infrared light is cast into the entire 350 degree field of view surrounding patrol car 500. Furthermore, the plurality of camera lenses may be configured to receive infrared light. Thus, 360 degree panoramic images may be captured in the absence of ambient light.

In some embodiments, the images captured by the panoramic camera system 100 may be still images. In some embodiments, panoramic camera system 100 may capture a series of panoramic images in rapid succession, i.e., panoramic video.

As described above, panoramic surveillance system 20 may include a control system. The control system may be in electronic communication with camera system 100. The control system may comprise a processor unit, data storage and a short-range receiver. The processor unit may be configured to process electronic instructions, such as to capture one or more images, store them, and/or transmit them to a remote server. The data storage may be configured to store image data based on the captured images. The short-range receiver may be configured to receive instructions from a wireless remote unit and pass the instructions to the processor unit.

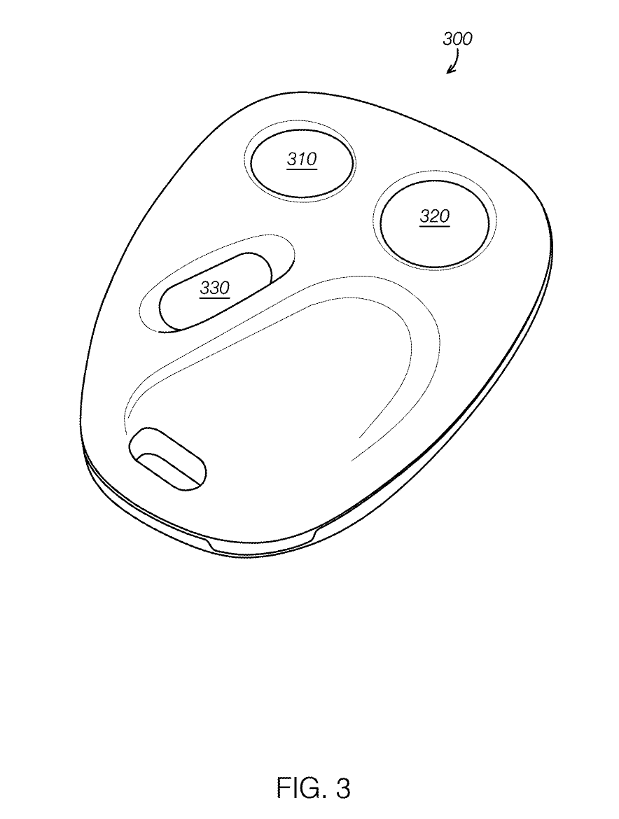

Turning now to FIG. 3, one embodiment of a wireless remote unit, remote unit 300 is shown. Remote unit 300 includes one or more buttons 310, 320, 330 to allow the user to input instructions, which are then wirelessly transmitted via remote unit 300 to the short-range receiver of the control unit. For example, the user may push button 310 to begin recording panoramic video. As another example, the user may push button 320 to begin recording sound. As another example the user may push button to 330 to place the panoramic surveillance system 20 into night vision into night vision mode, thereby activating the infrared light sources. Thus, a user may activate the features of the panoramic surveillance system 20 from anywhere in vicinity of patrol car 500.

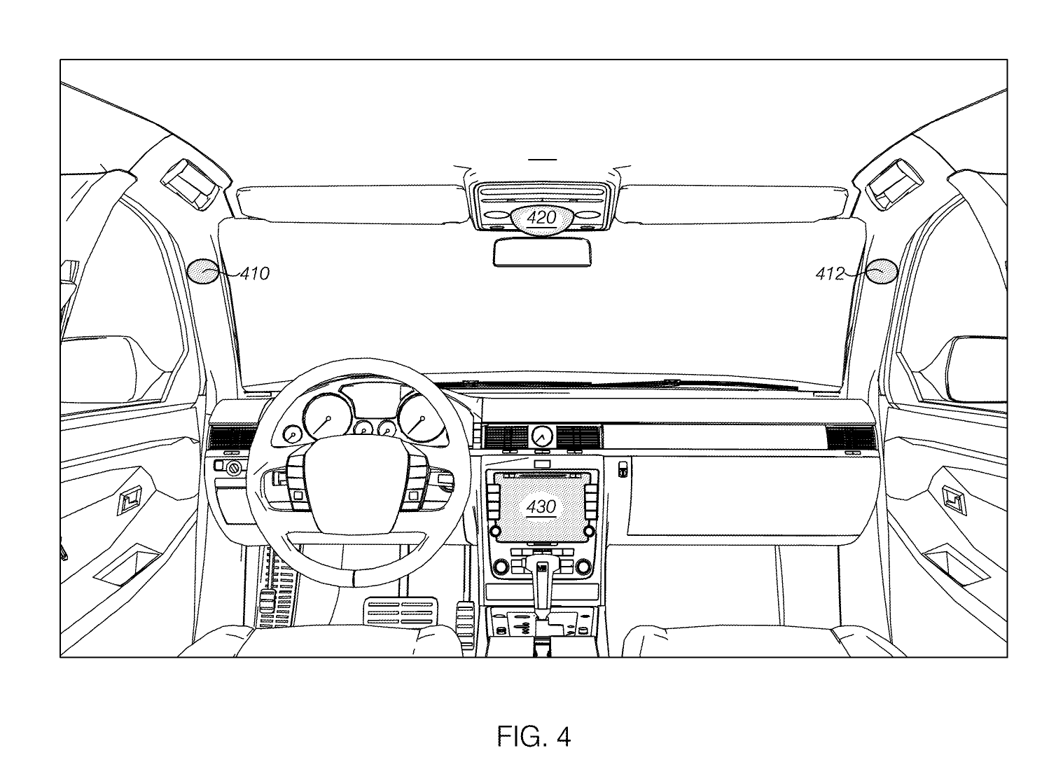

Turning now to FIG. 4, one embodiment of the interior of patrol car 500 is shown. In the illustrated embodiment, the panoramic surveillance system 20 includes an auxiliary camera system. The auxiliary camera system comprises one or more interior cameras 410, 412, 420. Interior cameras 410, 412, 420 are configured to capture images of the interior of the patrol car 500.

The interior cameras may be in electronic communication with the control system.

The interior of the patrol car may include control system interface 430. A user may input instructions to the control system via interface 430. The auxiliary camera system may include one or interior microphones to record sound within the patrol car 500. The interior microphones may be in electronic communication with the control system.

In some embodiments, the panoramic surveillance system 20 may include a Global Positioning System (GPS) device. Thus, the location of the vehicle may be recorded and stored, via the control system, along with images captured. The GPS data may correlated to the images, such that the image data includes corresponding location data.

In some embodiments, the control system of may include a long-range transmitting system. The long range transmitting system may be configured to transmit image data, GPS data, and or audio data to a remote server system. The remote server system may store the image data.

In some embodiments, the remote server system may be configured to send instructions to the control system. Thus, in some embodiments, a remote operator may have the ability to, for example, start the image capturing process.

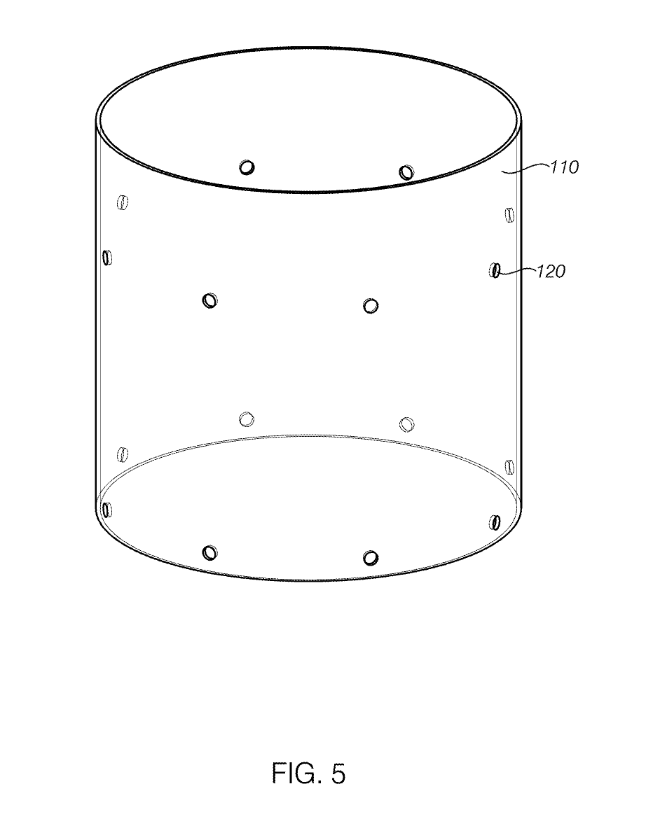

Turning now to FIG. 5, an exterior housing 110 is shown. Exterior housing 110 is configured to house components of the panoramic surveillance system 20. For example, exterior housing may house one or more exterior microphones. Furthermore, in some embodiments, exterior housing 110 may house panoramic camera system 100. Exterior housing 110 may contain a portion of the exterior mounted components of system 20, or it may contain all of such exterior mounted components. Exterior housing functions to protect the components within it from the elements. Exterior housing 110 may include a plurality of perforations 120 to allow sound to pass into the interior of the housing.

Exterior housing 110 may be mounted on the exterior of patrol vehicle 500. For example, exterior housing 110 may be mounted above panoramic camera system 100.

In some embodiments, the panoramic surveillance system 20 may include a sound sensor. The sound sensor may be configured to sense one or more violent sounds, including but not limited to gunshots, explosions, and/or high energy impacts. In some embodiments, the control system may be configured to automatically begin recording panoramic images when a violent sound is detected via the sound sensor.

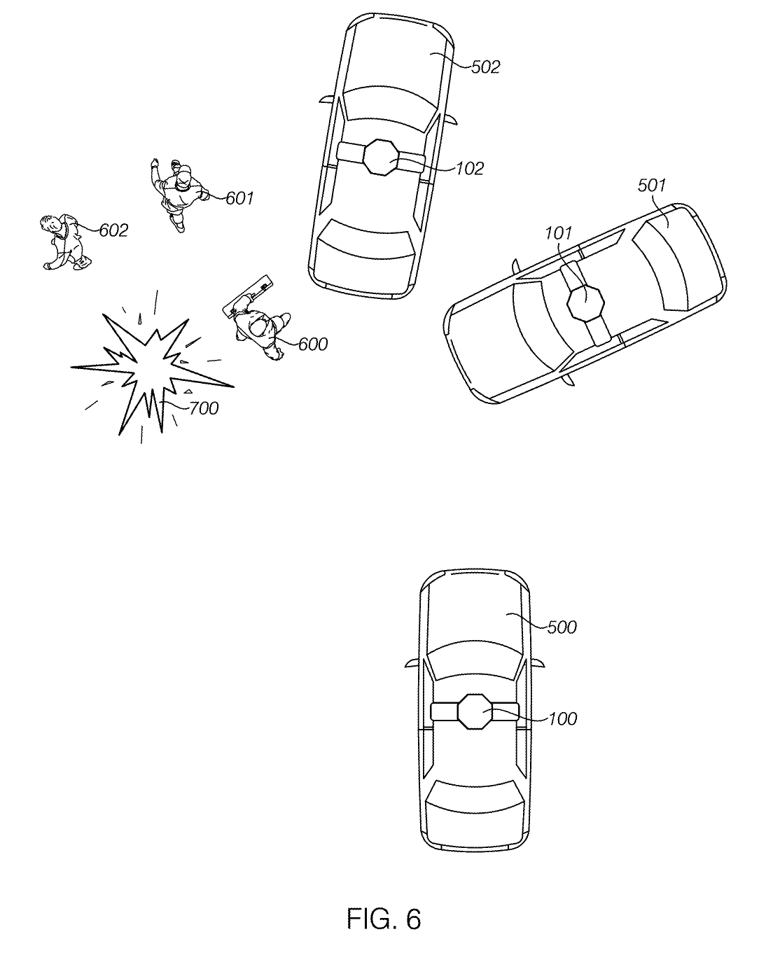

Turning now to FIG. 6, a plan view of activities being captured via a plurality of panoramic surveillance systems is shown. In the illustrated embodiment, 360 degree panoramic camera systems 100, 102, 103 are mounted on respective patrol cars 500, 501, 502. In the illustrated embodiment, an explosion 700 occurs near officers 600, 601, 602. Images and sounds of the scene may be captured and recorded via panoramic camera systems 100, 102, 103. As can be appreciated by the reader, the panoramic surveillance systems described herein may be indispensable in this and a wide variety of other scenarios to document events.

In operation, the panoramic surveillance system 20 may be used in a method of collecting information from a vehicle. In one embodiment, the method may include arming the panoramic surveillance system 20. The method may further include triggering the surveillance system. The method may include obtaining, in response to the triggering step, a series of panoramic images via the camera system.

The method may include obtaining, in response to the triggering step, image data a series of interior images via the auxiliary camera system. The method may also include obtaining, in response to the triggering step, sound data from the exterior microphones and/or interior microphones. In some embodiments, the interior images, the panoramic images and the sound data are obtained concurrently. In this regard, a synchronized visual and audio record of events both exterior and interior to the vehicle may be recorded.

The method may include storing the sound data and or image data (i.e., the series of panoramic image and/or interior images).

In some embodiments, the triggering step may comprise transmitting a short-range signal to the short range receiver of the control system via the wireless remote unit 300. For example, as described above, a user may push a button on the wireless remote unit to begin recoding video and/or audio. In some embodiments, the triggering step may comprise recognizing a violent sound, such as a gunshot or explosion, via the sound sensor and sending a signal to the control system in response.

In some embodiments, the storing step may comprise storing the GPS location of the vehicle during the obtaining step.

In some embodiments, the method may include transmitting image data and/or sound data via a long-range transmitting system of the control system to the remote server. In some embodiments, the image data and/or sound data may be stored in the remote server.

In some embodiments, the triggering step may include sending a long-range signal from the remove server to the control system.

In some embodiments, the obtaining step may include obtaining a series of images via an auxiliary camera system mounted in the vehicle. This series of images may be stored and transmitted along with the series of panoramic images.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method of collecting information via a vehicle, the method comprising:
arming a panoramic surveillance system, the panoramic surveillance system comprising:
a panoramic camera system mounted to a roof of the vehicle, the camera system configured to receive electromagnetic radiation from a 360 degree field of view surrounding the vehicle;
a control system in electronic communication with the camera system, the control system comprising:
a processor unit configured to process electronic instructions;
data storage configured to store image data; and
a short-range receiver configured to receive instructions and pass them to the processor unit;
triggering the surveillance system;
obtaining, in response to the triggering step, a series of instantaneous 360 degree panoramic images via the camera system;
storing the series of panoramic images in the data storage of the control system.

2. The method of claim 1, wherein the camera system comprises a plurality of digital camera lenses each having a respective field of view, wherein the camera lenses are arranged around a common center point such that the field of view of each camera lens overlaps with the field of view of its neighboring camera lenses.

3. The method of claim 2, wherein the camera system comprises eight camera lenses.

4. The method of claim 1, wherein the panoramic surveillance system comprises a plurality of infrared light sources configured to cast infrared light into the 360 degree field of view surrounding the vehicle, and wherein the camera system is configured to receive infrared light.

5. The method of claim 1, wherein the series of panoramic images comprises panoramic video.

6. The method of claim 1, wherein the panoramic surveillance system comprises an auxiliary camera system configured to receive electromagnetic radiation from an interior portion of the vehicle, the method comprising:
concurrent to the obtaining step, capturing a series of images of the interior of the vehicle via the auxiliary camera system.

7. The method of claim 1, wherein the panoramic surveillance system comprises a wireless remote unit, and wherein the triggering step comprises transmitting a short-range signal to the short-range receiver via the wireless remote unit.

8. The method of claim 1, wherein the panoramic surveillance system comprises a sound sensor configured to recognize a violent sound, and wherein the triggering step comprises sending a signal to the processor via the sound sensor.

9. The method of claim 1, wherein the panoramic surveillance system comprises a GPS device, and wherein the storing step comprises storing the location of the vehicle during the obtaining step.

10. A method of collecting information via a vehicle, the method comprising:
arming a panoramic surveillance system, the panoramic surveillance system comprising:
a panoramic camera system mounted to a roof of the vehicle, the camera system configured to receive electromagnetic radiation from a 360 degree field of view surrounding the vehicle;
a control system in electronic communication with the camera system, the control system comprising:
a processor unit configured to process electronic instructions;
data storage configured to store image data; and
a short-range receiver configured to receive instructions and pass them to the processor unit; and
a long-range transmitting system configured to transmit image data to a remote server;
triggering the surveillance system;
obtaining, in response to the triggering step, a series of instantaneous 360 degree panoramic images via the camera system;
storing the series of panoramic images in the data storage of the control system;
transmitting the series of panoramic images via the long-range transmitter to the remote server;
storing the series of panoramic images in the remote server.

11. The method of claim 11, wherein panoramic surveillance system comprises a plurality of microphones configured to record sound data in the vicinity of the exterior of the vehicle.

12. The method of claim 11, wherein panoramic surveillance system comprises a plurality of microphones configured to record sound data in the vicinity of the interior of the vehicle.

13. The method of claim 11, wherein the panoramic surveillance system comprises a plurality of infrared light sources configured to cast infrared light into the 360 degree field of view surrounding the vehicle, and wherein the camera system is configured to receive infrared light.

14. The method of claim 11, wherein the series of panoramic images comprises panoramic video.

15. The method of claim 11, wherein the panoramic surveillance system comprises an auxiliary camera system configured to receive electromagnetic radiation from an interior portion of the vehicle, the method comprising:
concurrent to the obtaining step, capturing a series of images of the interior of the vehicle via the auxiliary camera system.

16. The method of claim 111, wherein the panoramic surveillance system comprises a wireless remote unit, and wherein the triggering step comprises transmitting a short-range signal to the short-range receiver via the wireless remote unit.

17. The method of claim 11, wherein the panoramic surveillance system comprises a sound sensor configured to recognize a violent sound, and wherein the triggering step comprises sending a signal to the processor via the sound sensor.

18. The method of claim 11, wherein the panoramic surveillance system comprises a long-range receiver, and wherein the triggering step comprises sending a signal to the processor via a long-rage transmitter.

19. The method of claim 11, wherein the panoramic surveillance system comprises a GPS device, and wherein the storing step comprises storing the location of the vehicle at during the obtaining step.

20. A method of collecting information via a vehicle, the method comprising:
arming a panoramic surveillance system, the panoramic surveillance system comprising:
a panoramic camera system mounted to a roof of the vehicle, the camera system configured to receive electromagnetic radiation from a 360 degree field of view surrounding the vehicle;
one or more microphones mounted on an exterior of the vehicle and configured to produce sound data;
a control system in electronic communication with the camera system, the control system comprising:
a processor unit configured to process electronic instructions;
data storage configured to store image data; and
a short-range receiver configured to receive instructions and pass them to the processor unit;
a long-range transmitting system configured to transmit image and sound data to a remote server; and
an auxiliary camera system configured to receive electromagnetic radiation from an interior portion of the vehicle;
triggering the surveillance system;
obtaining, in response to the triggering step:
a series of instantaneous 360 degree panoramic images via the panoramic camera system;
a series of interior images via the auxiliary camera system; and
sound data via the one or more microphones;
wherein the interior images, the panoramic images and the sound data are obtained concurrently;
storing the obtained images and sound data in the data storage of the control system;
transmitting the obtained images and sound data via the long-range transmitter;
storing the obtained images and sound data in the remote server.
